(19) United States
(12) Patent Application Publication
(10) Pub. No.: US 2026/0031488 A1
(43) Pub. Date: Jan. 29, 2026

(54) BATTERY PACK AND ELECTRICAL APPARATUS

(71) Applicant: EVE ENERGY CO., LTD., Huizhou (CN)

(72) Inventors: Lei WANG, Huizhou (CN); Yanyan LI, Huizhou (CN); Guojiang ZHANG, Huizhou (CN)

(73) Assignee: EVE ENERGY CO., LTD., Huizhou (CN)

(21) Appl. No.: 19/344,200

(22) Filed: Sep. 29, 2025

Related U.S. Application Data
(63) Continuation of application No. PCT/CN2023/089433, filed on Apr. 20, 2023.

(30) Foreign Application Priority Data
Mar. 31, 2023 (CN) 202310332944.8
Mar. 31, 2023 (CN) 202320682443.8

(51) Int. Cl. H01M 50/503; H01B 7/00; H01M 10/42; H01M 50/507; H01M 50/517; H01M 50/522

(52) U.S. Cl. CPC H01M 50/503; H01M 10/425; H01M 50/507; H01M 50/517; H01M 50/522; H01B 7/0045; H01M 2010/4271

(57) ABSTRACT

The application discloses a battery pack and electrical apparatus. The battery pack includes a box body, a battery module, a battery management system, a high-voltage distribution box, and a sensor located inside the box body. The high-voltage distribution box includes a high-voltage distribution box body and an integrated wire harness. A plurality of wire harnesses are integrated in the integrated wire harness, and the wire harnesses extend from the high-voltage distribution box body in a direction toward the battery management system. The battery management system is connected to the battery module, the high-voltage distribution box, the sensor, and a port of the box body through the wire harnesses.

### CROSS-REFERENCE TO RELATED APPLICATION

The present application is a continuation application of International Application No. PCT/CN2023/089433 filed on Apr. 20, 2023, which claims priority to Chinese patent application No. 202310332944.8 filed with the China National Intellectual Property Administration (CNIPA) on Mar. 31, 2023 and priority to Chinese patent application No. 202320682443.8 filed with the CNIPA on Mar. 31, 2023, the entire contents of which are incorporated herein by reference.

### TECHNICAL FIELD

The present application relates to the field of battery technology, particularly to a battery pack and electrical apparatus.

### BACKGROUND

As one of the core components of electric vehicles, a power battery serves as the energy hub of an electric vehicle, while a high-voltage distribution box, as an energy distribution unit of the power battery, plays an irreplaceable role in the vehicle. Currently, a high-voltage distribution box (Battery Energy Distribution Unit, BDU) in a power battery pack is arranged on one side of the box as a distribution and voltage and/or current collection unit.

The design of a conventional high-voltage distribution box includes a base, an upper cover, a protective cover, and a wire harness connected to an external port of the high-voltage box. The high-voltage distribution box then transmits signals to a collection port of a battery management system (BMS) through a wire harness in the battery pack. The disadvantages are: a conventional high-voltage box has a large volume and a large number of components, especially since most internal connections of the high-voltage distribution box are made through wire harnesses, and there is more than one wire harness connection inside the high-voltage distribution box, which leads to disordered wire harnesses and increases production processes and manufacturing costs.

### SUMMARY

### Technical Problem

Embodiments of the present application provide a battery pack and electrical apparatus to address or at least partially address the shortcomings of the above background art.

### Technical Solution

To achieve the above functions, embodiments of the present application provide the following technical solutions:

In a first aspect, an embodiment of the present application provides a battery pack, including a box body, a battery module, a battery management system, a high-voltage distribution box, and a sensor that are located inside the box body;
the high-voltage distribution box includes a high-voltage distribution box body and an integrated wire harness, wherein a plurality of wire harnesses are integrated in the integrated wire harness, and the wire harnesses extend from the high-voltage distribution box body in a direction toward the battery management system; and
the battery management system is connected to the battery module, the high-voltage distribution box body, the sensor, and a port of the box body through the wire harnesses.

In an embodiment, the battery management system is spaced apart from the high-voltage distribution box body, and the battery management system and the high-voltage distribution box body are located on the same side inside the box body; and
the battery management system includes a plurality of terminal ports, wherein the terminal ports correspond to the wire harnesses respectively, and the wire harness extends from the terminal port in a direction toward the high-voltage distribution box body.

In an embodiment, the wire harnesses include a first wire harness, a second wire harness, and a third wire harness. The battery management system is connected to the high-voltage distribution box body through the first wire harness, is connected to the sensor through the second wire harness, and is connected to a low-voltage port of the box body through the third wire harness.

In an embodiment, a plurality of electrical components are disposed in the high-voltage distribution box body, and the plurality of the electrical components are connected through a busbar; and
the first wire harness includes a plurality of first sub-wire harnesses integrated together, and the first sub-wire harnesses are connected in pairs to the electrical components respectively.

In an embodiment, each of the electrical components includes a driving port located on a side of the electrical component close to a sidewall of the box body.

In an embodiment, the busbar includes a plurality of copper bars, and the copper bars are fixed to the electrical components.

In an embodiment, a plurality of blade terminals are disposed on the electrical component, and a plurality of collection points are disposed on the first sub-wire harness. The collection points are plugged into the blade terminals, and the blade terminals are riveted to the copper bars.

In an embodiment, the first sub-wire harnesses includes a cable tie buckle disposed on the first sub-wire harness, and the cable tie buckle is fastened to a housing of the electrical component.

In an embodiment, the plurality of the electrical components at least include a main positive relay, a main negative relay, a fast-charging relay, a main fuse, a pre-charge relay, a pre-charge resistor, and a pre-charge resistor.

In an embodiment, the sensor includes at least one of a pressure sensor or a temperature sensor, and the second wire harness includes a pressure collection wire harness or a temperature collection wire harness.

In an embodiment, each wire harness includes a wire core and a first insulating protective layer sleeved on a surface of the wire core; and
the integrated wire harness includes a second insulating protective layer provided on the integrated wire harness, wherein the second insulating protective layer is located on a side of the first insulating protective layer away from the wire core, and the second insulating protective layer is configured to integrate the plurality of the wire harnesses in the integrated wire harness.

In an embodiment, the high-voltage distribution box body includes an upper cover and a housing with an opening at one end of the housing, the upper cover is configured to seal the opening of the housing, and the upper cover is rotatably connected to the housing.

In an embodiment, the housing includes two rotation shafts disposed on two sides of the housing respectively, and the upper cover includes two rotation holes provided in the upper cover and corresponding to the rotation shafts respectively, and the rotation holes are fastened to the rotation shafts respectively;
in an open state of the upper cover relative to the housing, the upper cover is rotatably connected to the housing through the rotation shafts; and
in a closed state of the upper cover relative to the housing, the upper cover and the housing are fixedly connected through a fixing member.

In a second aspect, an embodiment of the present application provides an electrical apparatus, wherein the electrical apparatus includes a battery pack, and the battery pack includes a box body, a battery module, a battery management system, a high-voltage distribution box, and a sensor that are located inside the box body;
the high-voltage distribution box includes a high-voltage distribution box body and an integrated wire harness, wherein a plurality of wire harnesses are integrated in the integrated wire harness, and the wire harnesses extend from the high-voltage distribution box body in a direction toward the battery management system; and
the battery management system is connected to the battery module, the high-voltage distribution box body, the sensor, and a port of the box body through the wire harnesses.

In an embodiment, the battery management system is spaced apart from the high-voltage distribution box body, and the battery management system and the high-voltage distribution box body are located on the same side inside the box body; and
the battery management system includes a plurality of terminal ports, wherein the terminal ports correspond to the wire harnesses respectively, and the wire harness extends from the terminal port in a direction toward the high-voltage distribution box body.

### Beneficial Effects

Embodiments of the present application provide a battery pack and electrical apparatus. The battery pack includes a box body, a battery module, a battery management system, a high-voltage distribution box, and a sensor that are located inside the box body. The high-voltage distribution box includes a high-voltage distribution box body and an integrated wire harness, a plurality of wire harnesses are integrated in the integrated wire harness, and the wire harnesses extend from the high-voltage distribution box body in a direction toward the battery management system. The battery management system is connected to the battery module, the high-voltage distribution box, the sensor, and a port of the box body through the wire harnesses. The present application, by providing the high-voltage distribution box with the high-voltage distribution box body and the integrated wire harness, integrates a plurality of wire harnesses in the integrated wire harness, thereby improving the integration of the wire harnesses and reducing unnecessary winding of the wire harnesses, making the assembly of the battery pack more convenient, and improving the assembly efficiency of the battery pack.

### BRIEF DESCRIPTION OF THE DRAWINGS

The technical solutions and other beneficial effects of the present application will become apparent through a detailed description of specific embodiments of the present application in conjunction with the accompanying drawings.

FIG. 1 is a top cross-sectional view of a battery pack provided by an embodiment of the present application;

FIG. 2 is a structural schematic diagram of a high-voltage distribution box body provided by an embodiment of the present application;

FIG. 3 is a cross-sectional schematic diagram of a high-voltage distribution box body and an integrated wire harness provided by an embodiment of the present application;

FIG. 4 is an enlarged view of a region A in FIG. 3; and

FIG. 5 is a schematic diagram of an upper cover and a housing of a high-voltage distribution box body in an open state provided by an embodiment of the present application.

### DETAILED DESCRIPTION

The technical solutions in the embodiments of the present application will be clearly and completely described below in conjunction with the drawings in the embodiments of the present application. It is apparent that the described embodiments are only a part of the embodiments of the present application, not all of them. Based on the embodiments in the present application, all other embodiments obtained by those skilled in the art without creative efforts fall in the protection scope of the present application.

The present embodiment provides a battery pack and electrical apparatus. Detailed descriptions are provided below. It should be noted that the order of description of the following embodiments does not limit the preferred order of the embodiments.

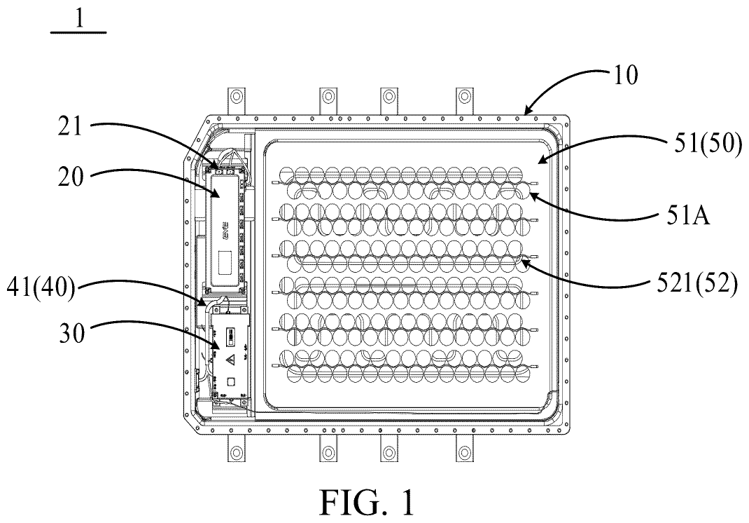

Referring to FIG. 1 to FIG. 4, the present embodiment provides a battery pack 1, and the battery pack 1 includes a box body 10, a battery module (not shown in the figures), a battery management system 20, a high-voltage distribution box, and a sensor (not shown in the figures) that are located inside the box body 10. The high-voltage distribution box includes a high-voltage distribution box body 30 and an integrated wire harness 40. A plurality of wire harnesses 41 are integrated in the integrated wire harness 40, and the wire harnesses 41 extend from the high-voltage distribution box body 30 in a direction toward the battery management system 20. The battery management system 20 is connected to the battery module, the high-voltage distribution box body 30, the sensor, and a low-voltage port 10A of the box body 10 through the integrated wire harness 40.

It should be noted that, in the related art, a high-voltage distribution box (Battery Energy Distribution Unit, BDU), as an energy distribution unit of a power battery, plays an irreplaceable role in the vehicle. Currently, the design of a high-voltage distribution box includes a base, an upper cover, and a wire harness connected to an external port of the high-voltage box. The high-voltage distribution box then transmits signals to a collection port of a battery management system (BMS) through a wire harness in the battery pack. The disadvantages are: a conventional high-voltage distribution box has a large volume and a large number of components, especially connections inside the high-voltage distribution box are made through wire harnesses, and more than one wire harness connection exits inside the high-voltage distribution box, which leads to disordered wire harnesses, increasing production processes and manufacturing costs.

It can be understood that, in the present embodiment, the high-voltage distribution box includes a high-voltage distribution box body 30 and an integrated wire harness 40. A plurality of wire harnesses 41 are integrated in the integrated wire harness 40, and the wire harnesses 41 extend from the high-voltage distribution box body 30 in a direction toward the battery management system 20. The battery management system 20 is connected to the battery module, the high-voltage distribution box body 30, the sensor, and a low-voltage port 10A of the box body 10 through the wire harnesses 41, thereby improving the integration of the wire harnesses 41 and reducing unnecessary winding of the wire harnesses 41, making the assembly of the battery pack 1 more convenient and improving the assembly efficiency of the battery pack 1.

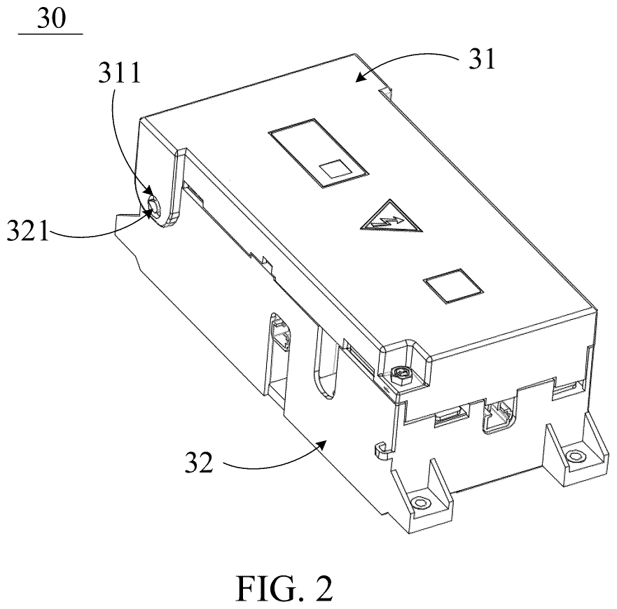

In an embodiment, referring to FIG. 1 and FIG. 2, FIG. 1 is a top cross-sectional view of a battery pack 1 provided by an embodiment of the present application, and FIG. 2 is a structural schematic diagram of a high-voltage distribution box body provided by an embodiment of the present application.

In the present embodiment, the battery pack 1 includes a box body 10 and a cover plate (not shown in the figures). The cover plate is installed on the box body 10, and a plurality of battery modules (not shown in the figures), a battery management system 20, a high-voltage distribution box, and a sensor, which are independently spaced apart, are disposed inside the box body 10. The high-voltage distribution box includes a high-voltage distribution box body 30 and an integrated wire harness 40.

The battery modules and the high-voltage distribution box body 30 are connected through a high-voltage connection copper bar 30C. A plurality of wire harnesses 41 are integrated in the integrated wire harness 40, and the wire harnesses 41 extend from the high-voltage distribution box body 30 in a direction toward the battery management system 20. The battery management system 20 is connected to the battery module, the high-voltage distribution box body 30, the sensor, and a low-voltage port 10A of the box body 10 through the wire harnesses 41.

It can be understood that, in the present embodiment, by arranging the components relatively independently without structural or connection sequence constraints, compared to other multilayer or irregularly shaped battery modules, the assembly process of the battery pack 1 is more convenient, thereby improving system assembly efficiency and significantly enhancing the reliability and stability of the battery module during installation.

Specifically, in the present embodiment, the battery management system 20 is spaced apart from the high-voltage distribution box body 30, and the battery management system 20 and the high-voltage distribution box body 30 are located on the same side inside the box body 10. The battery management system 20 includes a plurality of terminal ports 21, the terminal port 21 correspond to the wire harnesses 41 respectively, and the wire harness 41 extends from the high-voltage distribution box body 30 in a direction toward the terminal port 21.

It can be understood that, in the present embodiment, by spacing the battery management system 20 and the high-voltage distribution box body 30 on the same side of the box body 10, the distance between the battery management system 20 and the high-voltage distribution box body 30 is shortened, reducing the assembly time and length of the wire harnesses 41, thereby saving material costs.

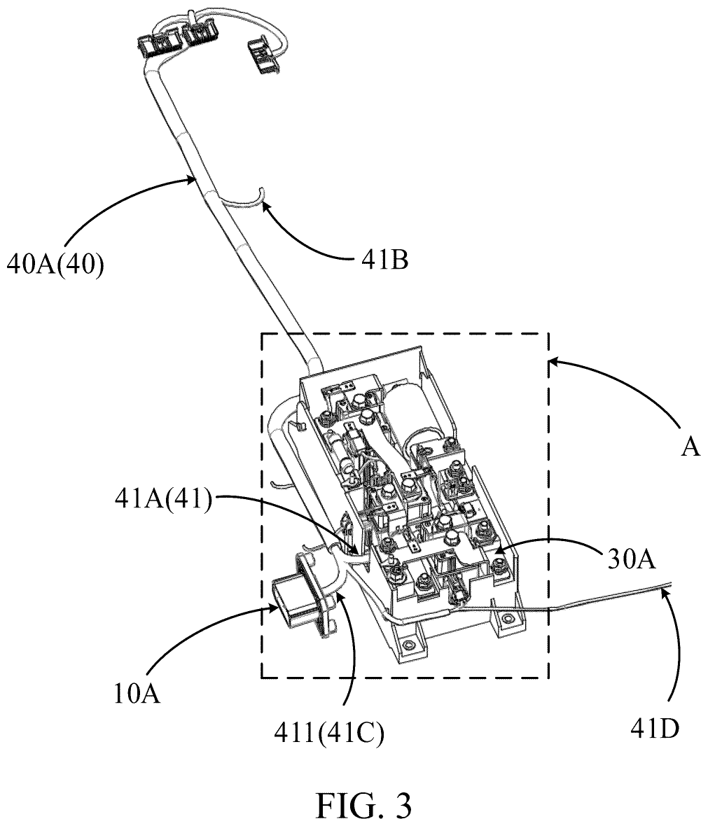

Further, referring to FIG. 2 and FIG. 3, FIG. 3 is a cross-sectional schematic diagram of the high-voltage distribution box body and the integrated wire harness provided by an embodiment of the present application, in the present embodiment, the high-voltage distribution box body 30 includes an upper cover 31 and a housing 32 with an opening at one end of the housing 32. The upper cover 31 is configured to seal the opening of the housing 32, and the upper cover 31 is rotatably connected to the housing 32. The integrated wire harness 40 is located between the housing 32 and the box body 10. By positioning the integrated wire harness 40 at a location easily accessible to maintenance personnel, there is no need to embed the integrated wire harness 40 in gaps between the plurality of the electrical components 30B, thereby improving assembly and maintenance efficiency.

In the present embodiment, each wire harness 41 includes a wire core and a first insulating protective layer 411 sleeved on a surface of the wire core. The integrated wire harness 40 is provided with a second insulating protective layer 40A, the second insulating protective layer 40A is located on a side of the first insulating protective layer 411 away from the wire core, and the second insulating protective layer 40A is configured to integrate the plurality of the wire harnesses 41 in the integrated wire harness 40.

It can be understood that, in the present embodiment, by sleeving the first insulating protective layer 411 on the surface of the wire core and positioning the second insulating protective layer 40A on a side of the first insulating protective layer 411 away from the wire core, the second insulating protective layer 40A integrates the plurality of the wire harnesses 41 in the integrated wire harness 40, thereby enhancing the flexibility and strength of the wire harnesses 41 and the integrated wire harness 40, thus avoiding risks such as damage or short circuits due to deformation or compression of the integrated wire harness 40.

In the present embodiment, the wire harnesses 41 include a first wire harness 41A, a second wire harness 41B, and a third wire harness 41C. The battery management system 20 is connected to the high-voltage distribution box body 30 through the first wire harness 41A, is connected to the sensor through the second wire harness 41B, and is connected to a low-voltage port 10A of the box body 10 through the third wire harness 41C.

It can be understood that, in the present embodiment, by integrating the first wire harness 41A, the second wire harness 41B, and the third wire harness 41C into the integrated wire harness 40, the integration of the wire harnesses 41 is improved, and unnecessary winding of the wire harnesses 41 is reduced, making the assembly of the battery pack 1 more convenient and improving the assembly efficiency of the battery pack 1.

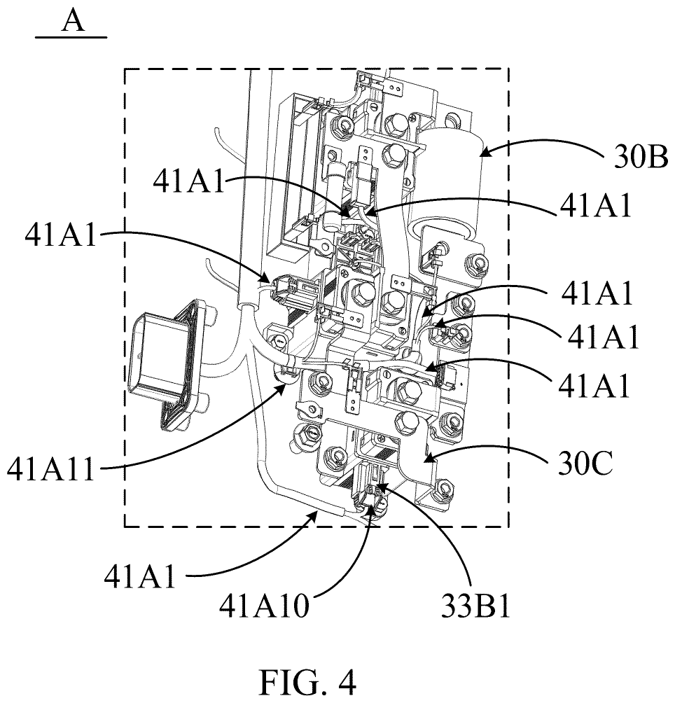

Further, referring to FIG. 3 and FIG. 4, FIG. 4 is an enlarged view of a region A in FIG. 3, in the present embodiment, the high-voltage distribution box body 30 is provided with a receiving cavity 30A, the receiving cavity 30A includes a plurality of electrical components 30B, and the plurality of the electrical components 30B are connected through a plurality of copper bars 30C. The first wire harness 41A includes a plurality of first sub-wire harnesses 41A1 integrated together, and the first sub-wire harnesses 41A1 are connected in pairs to the electrical components 30B.

Specifically, in the present embodiment, a plurality of installation slots are disposed in the receiving cavity 30A, and each electrical component 30B is fastened into one of the installation slots. The plurality of the electrical components 30B include a main positive relay, a main negative relay, a fast-charging relay, a main fuse, a pre-charge relay, a pre-charge resistor, and a pre-charge resistor.

It can be understood that the plurality of the electrical components 30B are commonly used components in the prior art, and specific structures and connection methods of the electrical components 30B are not described in detail here. The electrical components 30B also include a plurality of copper bars 30C, the copper bars 30C are fixed to the housing 32, and a stud is movably connected to the housing 32.

Preferably, the first sub-wire harnesses 41A1 include, but are not limited to, one of a relay control wire harness, a voltage collection wire harness, or a current collection wire harness. The present embodiment does not impose specific limitations.

Preferably, in the present embodiment, each of the electrical components 30B includes a driving port located on a side of the electrical component 30B close to a sidewall of the box body 10. Specifically, the driving port of each of the electrical components 30B is located on a side of the electrical component 30B close to the housing 32. It can be understood that, in the present embodiment, by positioning the driving ports of the plurality of the electrical components 30B on a side close to the housing 32, the driving ports of the electrical components 30B do not occupy space in the high-voltage distribution box body 30.

Preferably, in the present embodiment, a plurality of blade terminals 33B1 are disposed on the electrical component 30B, and a plurality of collection points 41A10 are disposed on the first sub-wire harness 41A1. The collection points 41A10 are plugged into the blade terminals 33B1, and the blade terminals 33B1 are riveted to the copper bars 30C. It can be understood that, by plugging the collection points 41A10 into the blade terminals 33B1 and riveting the blade terminals 33B1 to the copper bars 30C, a quick-plug terminal is used at an end of the collection signal wire harness 41, thereby improving the production efficiency of the battery pack 1.

Preferably, in the present embodiment, the first sub-wire harnesses 41A1 includes a cable tie buckle 41A11 disposed on the first sub-wire harness 41A1, and the cable tie buckle 41A11 is fastened to a housing of the electrical component 30B. It can be understood that, in the present embodiment, by providing the cable tie buckle 41A11 to limit the first sub-wire harnesses 41A1, the issue of the first sub-wire harnesses 41A1 becoming loose due to external vibrations is avoided.

Further, in the present embodiment, the wire harnesses 41 further include a fourth wire harness 41D, and the fourth wire harness 41D includes a plurality of high-voltage interlocking wire harnesses. The fourth wire harness 41D is drawn from the integrated wire harness 40 at a preset position and used for electrical connection. It can be understood that, in the present embodiment, by integrating the first wire harness 41A, the second wire harness 41B, the third wire harness 41C, and the fourth wire harness 41D into the integrated wire harness 40, the integration of the wire harnesses 41 is improved, and unnecessary winding of the wire harnesses 41 is reduced, making the assembly of the battery pack 1 more convenient and improving the assembly efficiency of the battery pack 1.

Further, in the present embodiment, the sensor includes, but is not limited to, one of a pressure sensor (Barometric Pressure Sensor, BPS) or a temperature sensor (Negative Temperature Coefficient, NTC). The second wire harness 41B includes, but is not limited to, one of a pressure collection wire harness or a temperature collection wire harness. The present embodiment does not impose specific limitations.

Specifically, in the present embodiment, the sensor may be located between the battery management system 20 and a bottom plate of the box body 10. The second wire harness 41B may be drawn from the integrated wire harness 40 at a position close to the sensor and used for electrical connection. Preferably, the sensor is a temperature sensor, and the second wire harness 41B is a temperature collection wire harness, and the battery management system 20 is connected to the temperature sensor through the temperature collection wire harness. Alternatively, the sensor is a pressure sensor, and the second wire harness 41B is a pressure collection wire harness, and the battery management system 20 is connected to the pressure sensor through the pressure collection wire harness. Alternatively, a sensor module includes the temperature sensor and the pressure sensor as above, and the battery management system 20 is connected to the temperature sensor and the pressure sensor of the sensor module respectively through the temperature collection wire harness and the pressure collection wire harness.

Further, in the present embodiment, a liquid cooling plate 50 is disposed between a bottom of the battery module and the battery pack 1. The liquid cooling plate 50 includes a heat dissipation plate 51 and a flow channel plate 52, and the flow channel plate 52 is located on a side of the heat dissipation plate 51 away from the battery module. A liquid cooling flow channel 521 is formed on a side of the flow channel plate 52 close to the heat dissipation plate 51. The liquid cooling flow channel 521 includes a plurality of parallel sub-flow channels, and each sub-flow channel includes a plurality of curved segments and a plurality of straight segments. Each of the curved segments is located between adjacent two of the straight segments, and each sub-flow channel is preferably a serpentine flow channel. The heat dissipation plate 51 is provided with a plurality of array-arranged heat dissipation holes 51A, thereby improving the cooling effect of the liquid cooling plate 50.

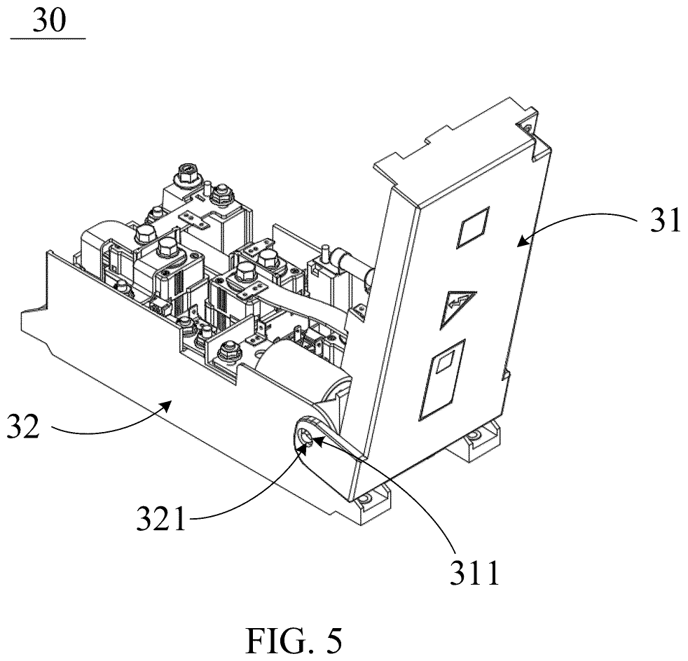

Further, referring to FIG. 2 and FIG. 5, FIG. 5 is a schematic diagram of an upper cover and a housing of a high-voltage distribution box body in an open state provided by an embodiment of the present application.

In the present embodiment, the housing 32 includes two rotation shafts 321 disposed on two sides of the housing 32, and the upper cover 31 is provided with two rotation holes 311 corresponding to the rotation shafts 321 respectively. The rotation holes 311 are fastened to the rotation shafts 321 respectively. In an open state of the upper cover 31 relative to the housing 32, the upper cover 31 is rotatably connected to the housing 32 through the rotation shafts 321. In a closed state of the upper cover 31 relative to the housing 32, the upper cover 31 and the housing 32 are fixedly connected through a fixing member. The fixing member includes, but is not limited to, a bolt.

It can be understood that, in the present embodiment, by providing the rotation shaft 321 on two sides of the housing 32 and the rotation hole 311 on the upper cover 31 corresponding to the rotation shaft 321 respectively. The rotation hole 311 is fastened to the rotation shaft 321, fault diagnosis and maintenance of the high-voltage distribution box body 30 are facilitated. Meanwhile, when the upper cover 31 and the housing 32 are fastened, the upper cover 31 and the housing 32 are fixedly connected through a bolt, thereby enhancing the stability of the high-voltage distribution box body 30.

The present embodiment provides an electrical apparatus, and the electrical apparatus includes the battery pack described in any of the above embodiments.

It can be understood that the battery pack has been described in detail in the above embodiments and will not be repeated here.

The battery pack includes a battery module, the battery module is used as a power supply for the electrical apparatus, and thus the electrical apparatus also has all the advantages of the battery module, thereby simplifying the overall structure of the electrical apparatus. The electrical apparatus may be a vehicle, an aircraft, mechanical production equipment, or the like.

In summary, the present application discloses a battery pack and electrical apparatus, and the battery pack includes a box body, a battery module, a battery management system, a high-voltage distribution box, and a sensor that are located inside the box body. The high-voltage distribution box includes a high-voltage distribution box body and an integrated wire harness, a plurality of wire harnesses are integrated in the integrated wire harness, and the wire harnesses extend from the high-voltage distribution box body in a direction toward the battery management system. The battery management system is connected to the battery module, the high-voltage distribution box, the sensor, and a port of the box body through the wire harnesses. The present application, by providing the high-voltage distribution box with the high-voltage distribution box body and the integrated wire harness, integrates a plurality of wire harnesses in the integrated wire harness, thereby improving the integration of the wire harnesses and reducing unnecessary winding of the wire harnesses, making the assembly of the battery pack more convenient and improving the assembly efficiency of the battery pack.

In summary, although the present application has been disclosed with preferred embodiments, these preferred embodiments are not intended to limit the invention. Those skilled in the art can make various modifications and refinements without departing from the spirit and scope of the invention. Therefore, the protection scope of the present application is subject to the scope defined by the claims.

1. A battery pack, comprising a box body, a battery module, a battery management system, a high-voltage distribution box, and a sensor that are located inside the box body;
wherein the high-voltage distribution box comprises a high-voltage distribution box body and an integrated wire harness, a plurality of wire harnesses are integrated in the integrated wire harness, and the wire harnesses extend from the high-voltage distribution box body in a direction toward the battery management system; and
wherein the battery management system is connected to the battery module, the high-voltage distribution box body, the sensor, and a low-voltage port of the box body through the wire harnesses.

2. The battery pack according to claim 1, wherein the battery management system is spaced apart from the high-voltage distribution box body, and the battery management system and the high-voltage distribution box body are located on a same side inside the box body; and
the battery management system comprises a plurality of terminal ports, the terminal ports correspond to the wire harnesses respectively, and the wire harness extends from the terminal port in a direction toward the high-voltage distribution box body.

3. The battery pack according to claim 2, wherein the wire harnesses comprise a first wire harness, a second wire harness, and a third wire harness, the battery management system is connected to the high-voltage distribution box body through the first wire harness, is connected to the sensor through the second wire harness, and is connected to a low-voltage port of the box body through the third wire harness.

4. The battery pack according to claim 3, wherein a plurality of electrical components are disposed in the high-voltage distribution box body, and the plurality of the electrical components are connected through a busbar; and
the first wire harness comprises a plurality of first sub-wire harnesses integrated together, and the first sub-wire harnesses are connected in pairs to the electrical components respectively.

5. The battery pack according to claim 4, wherein each of the electrical components comprises a driving port located on a side of the electrical component close to a sidewall of the box body.

6. The battery pack according to claim 4, wherein the busbar comprises a plurality of copper bars, and the copper bars are fixed to the electrical components.

7. The battery pack according to claim 6, wherein a plurality of blade terminals are disposed on the electrical component, and a plurality of collection points are disposed on the first sub-wire harness, the collection points are plugged into the blade terminals, and the blade terminals are riveted to the copper bars.

8. The battery pack according to claim 4, wherein the first sub-wire harness comprises a cable tie buckle disposed on the first sub-wire harness, and the cable tie buckle is fastened to the electrical component.

9. The battery pack according to claim 4, wherein the plurality of the electrical components at least comprise a main positive relay, a main negative relay, a fast-charging relay, a main fuse, a pre-charge relay, a pre-charge resistor, and a pre-charge resistor.

10. The battery pack according to claim 3, wherein the sensor comprises at least one of a pressure sensor or a temperature sensor, and the second wire harness comprises at least one of a pressure collection wire harness or a temperature collection wire harness.

11. The battery pack according to claim 1, wherein each wire harness comprises a wire core and a first insulating protective layer sleeved on a surface of the wire core; and
the integrated wire harness comprises a second insulating protective layer provided on the integrated wire harness, the second insulating protective layer is located on a side of the first insulating protective layer away from the wire core, and the second insulating protective layer is configured to integrate the plurality of the wire harnesses in the integrated wire harness.

12. The battery pack according to claim 2, wherein the high-voltage distribution box body comprises an upper cover and a housing with an opening at one end of the housing, wherein the upper cover is configured to seal the opening of the housing, and the upper cover is rotatably connected to the housing.

13. The battery pack according to claim 12, wherein the housing comprises two rotation shafts disposed on two sides of the housing respectively, and the upper cover comprises two rotation holes provided in the upper cover and corresponding to the rotation shafts respectively, and the rotation holes are fastened to the rotation shafts respectively;
in an open state of the upper cover relative to the housing, the upper cover is rotatably connected to the housing through the rotation shafts; and
in a closed state of the upper cover relative to the housing, the upper cover and the housing are fixedly connected through a fixing member.

14. An electrical apparatus, comprising a battery pack, wherein the battery pack comprises a box body, a battery module, a battery management system, a high-voltage distribution box, and a sensor that are located inside the box body;
the high-voltage distribution box comprises a high-voltage distribution box body and an integrated wire harness, a plurality of wire harnesses are integrated in the integrated wire harness, and the wire harnesses extend from the high-voltage distribution box body in a direction toward the battery management system; and
the battery management system is connected to the battery module, the high-voltage distribution box body, the sensor, and a low-voltage port of the box body through the wire harnesses.

15. The electrical apparatus according to claim 14, wherein the battery management system is spaced apart from the high-voltage distribution box body, and the battery management system and the high-voltage distribution box body are located on a same side inside the box body; and
the battery management system comprises a plurality of terminal ports, the terminal ports correspond to the wire harnesses respectively, and the wire harness extends from the terminal port in a direction toward the high-voltage distribution box body.

16. The electrical apparatus according to claim 15, wherein the wire harnesses comprise a first wire harness, a second wire harness, and a third wire harness, the battery management system is connected to the high-voltage distribution box body through the first wire harness, is connected to the sensor through the second wire harness, and is connected to a low-voltage port of the box body through the third wire harness.

17. The electrical apparatus according to claim 16, wherein a plurality of electrical components are disposed in the high-voltage distribution box body, and the plurality of the electrical components are connected through a busbar; and
the first wire harness comprises a plurality of first sub-wire harnesses integrated together, and the first sub-wire harnesses are connected in pairs to the electrical components respectively.

18. The electrical apparatus according to claim 17, wherein a driving port of each of the electrical components is located on a side of the electrical component close to a sidewall of the box body.

19. The electrical apparatus according to claim 17, wherein the busbar comprises a plurality of copper bars, and the copper bars are fixed to the electrical components.

20. The electrical apparatus according to claim 19, wherein a plurality of blade terminals are disposed on the electrical component, and a plurality of collection points are disposed on the first sub-wire harness, the collection points are plugged into the blade terminals, and the blade terminals are riveted to the copper bars.
